(19) United States
(12) Patent Application Publication
(10) Pub. No.: US 2005/0158045 A1
(43) Pub. Date: Jul. 21, 2005

(54) Image management method for an image-capturing apparatus

(75) Inventor: Xie Bin, Dong-Guan City (CN)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 10/892,142

(22) Filed: Jul. 16, 2004

(30) Foreign Application Priority Data
Jan. 20, 2004 (TW) 093101529

(51) Int. Cl. G03B 17/00

(52) U.S. Cl. 396/287

(57) ABSTRACT

A file managing method for an image capturing apparatus includes selecting at least one image from a plurality of images captured by the image capturing apparatus as a directory name of the plurality of images.

### BACKGROUND OF INVENTION

1. Field of the Invention

The present invention relates to a method for an image capturing apparatus, and more specifically, to a method for shortening display interval between displaying two images for an image capturing apparatus.

2. Description of the Prior Art

Conventional film cameras utilize chemicals on a film to record images, which can be viewed after development. Moreover, if a user wants to take pictures with special effects, the user is required to be skillful in controlling the stop, the shutter as well as the lens and film development, which is inconvenient for an amateur. In contrast to the conventional film cameras, digital cameras convert images into digital signals by a photosensor to directly store them into a memory device in image format compatible with a computer. Digital cameras can also be connected to a computer system and store images on its hard disk drive. The images can then be viewed on a screen or printed on a printer. In addition, the user can further process the images recorded by the digital camera using: image processing software to produce special effects, which previously could only be realized by a professional photographer with a conventional optical camera, or perhaps even could not be achieved using a conventional optical camera.

The digital cameras are increasingly popular, but it is not easy for user to manage a amount of taken pictures. Before showing a picture, a processor of the digital camera will read the picture from the memory which stores the taken pictures in digital image formats, such as JPEG. Sometimes, the user wants to view a specific picture, he has to spend much time to view pictures one by one. That is very inconvenient for a non-patient user. In order to solve such problem, U.S. Pat. No. 6,542,192 and No. 6,147,703, disclose resolutions that candidate pictures in low resolution and in smaller size are being showed at the corner of a display as a selected pictures is being showed. The user is able to select the required picture from the candidate pictures, which is then displayed in high resolution. In doing so, a period of processing picture can be shortened, because the required picture is read in advance. But the pictures in low resolution and in smaller size are vaguer than those in high resolution, so that the user sometimes fails to distinguish which picture he wants. If a non-recognized picture is selected, the user has to spend extra time to search the accuracy picture again, which indeed causes time to be wasted.

### SUMMARY OF INVENTION

It is therefore a primary objective of the present invention to provide a method of shortening a period of displaying images for an image capturing apparatus, in order to solve the problems mentioned above.

Briefly summarized, a file managing method for an image capturing apparatus includes selecting at least one image from a plurality of images captured by the image capturing apparatus as a directory name of the plurality of images.

According to the claimed invention, a digital camera includes a memory for storing a plurality of taken images in sequence, a control button set for selecting a image from the plurality of images captured by the digital camera, a display screen for displaying the selected image, and a cache for temporarily storing at least one of the previous displayed images and at least one of the next images corresponding to the selected image before displaying the selected image.

The claimed invention can read a selected image, a previous displayed image and a next image with respect to the selected image, after the previous image is displayed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a front view of an image capturing apparatus according to the present invention.

FIG. 2 is a rear view of the image capturing apparatus shown in FIG. 1.

FIG. 3 is a functional block diagram of the image capturing apparatus shown in FIG. 1.

FIG. 4 is a flowchart of the file managing method for the image capturing apparatus according to the present invention.

FIG. 5 is a flowchart of the file managing method used in the present invention.

### DETAILED DESCRIPTION

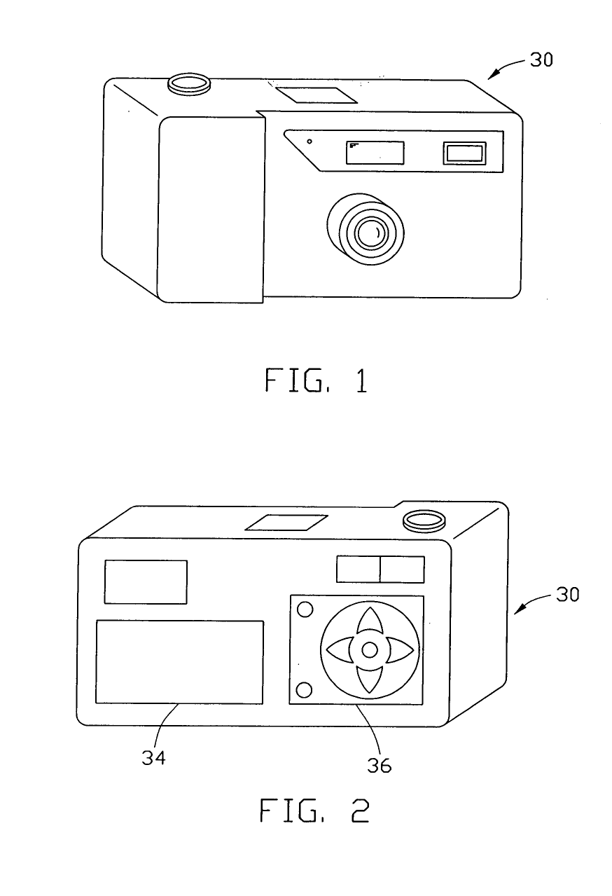

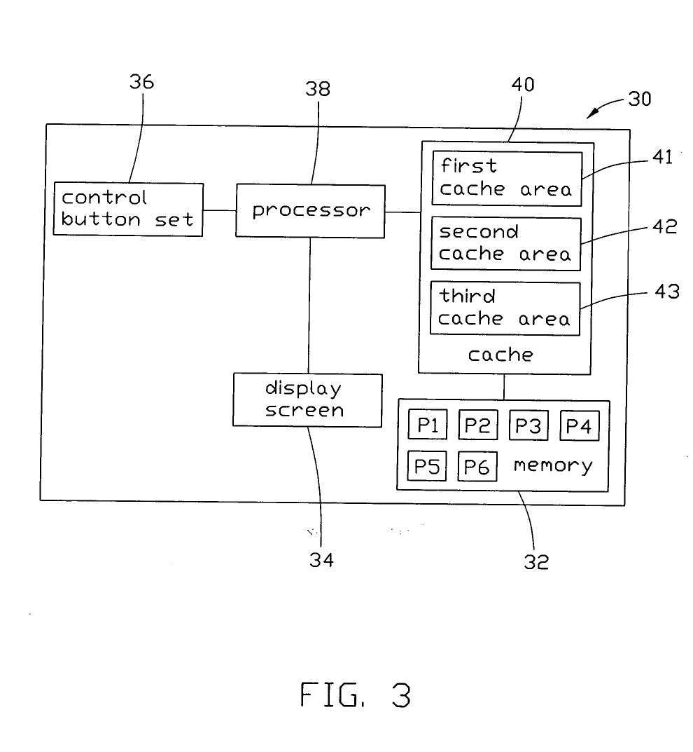

Please refer to FIG. 1 showing a front view of an image capturing apparatus 30 according to the present invention, FIG. 2 showing a rear view of the image capturing apparatus 30 shown in FIG. 1, and FIG. 3 showing a functional block diagram of the image capturing apparatus 30 shown in FIG. 1. The image capturing apparatus 30 can be a digital camera or a digital camcorder. The image capturing apparatus 30 includes a memory 32 for storing a plurality of taken pictures, a display screen 34 for viewing the object, which can be a LCD or a LTPS display, a control button set 36 for image editing, browsing, and parameter settings, a processor 38 for processing the images stored in the memory 32 so as to display on the display screen 34 and a cache 40 for temporarily storing the images stored in the memory 32, which can be a synchronous DRAM.

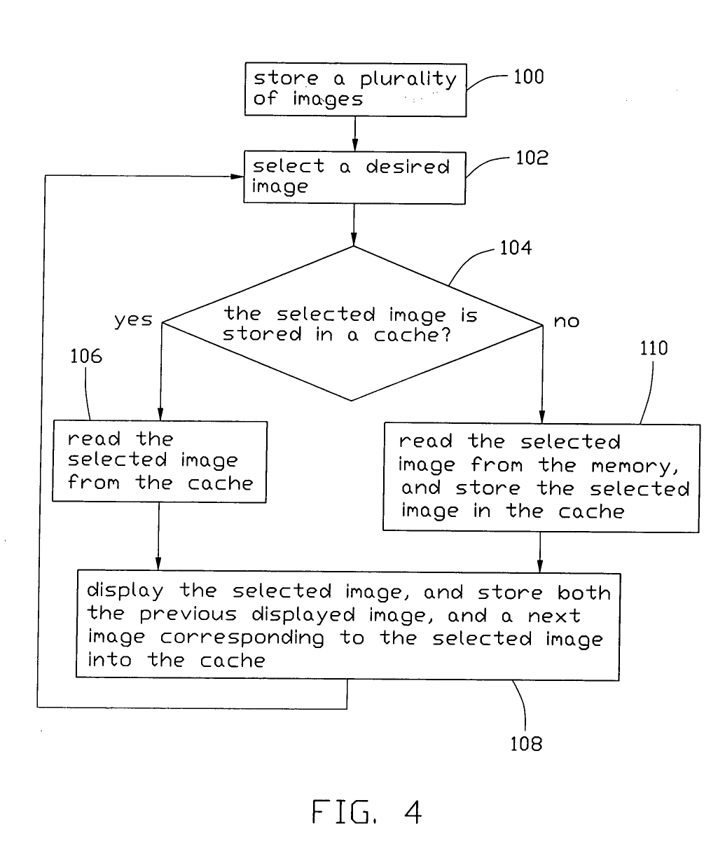

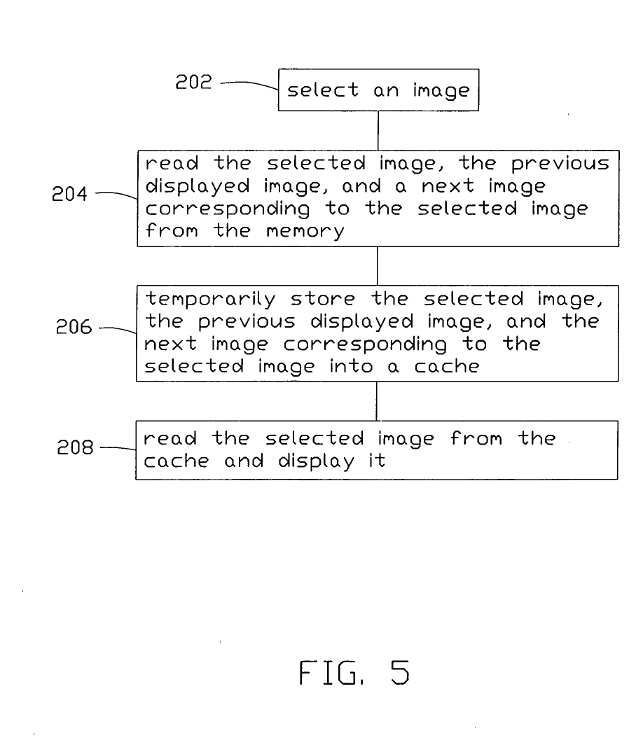

Concerning the improved method provided by the present invention, please refer to FIG. 4 showing a flowchart of the file managing method for the image capturing apparatus according to the present invention. It occurs as follows:

Step100: Store a plurality of taken images to a memory in sequence.

Step102: Select an image.

Step104: Whether the cache stores the image. If it is, go to Step 106, if not go to Step 110.

Step106: Read the image from the cache.

Step108: Display the image, and read a previous image of the image and a next image corresponding to the image from the memory, and temporarily stores in a second cache area and a second cache area.

Step110: Read the image from the memory.

In order to illustrates the present invention in detail, suppose that the digital camera 30 stores images P1-P6 in sequence. The user manipulates the control button set 36 to view the image P1 (as described in Step 102). Meanwhile, the processor 38 determines whether the cache 40 stores the image P1 or not. Because the image P1 is not stored in the cache 40, it will be read from the memory 32 and temporarily stored into a first cache area 41. The image P1 stored in the first cache area 41 can be processed by the processor 38 and then displayed on the display screen 34. When the image P1 is being displayed, the image P2 is also read from the memory 32 and temporarily stored in the second cache area 42, and the image P6 is stored in the third cache area 43. Then, the user can manipulate the control button set 36 to view the next image P2, as the processor 38 can determine whether the image P2 is stored in the cache 40. Because the image P2 is stored in the second cache area 42 in advance when the image P1 is being displayed, it can be processed by the processor 38 and then displayed on the display screen 34. When the image P2 is being displayed, the image P3 is read from the memory 32 and temporarily stored in the third cache area 43, and the previous displayed image P1 is still stored in the first cache area 41. If desiring to view the image P3, the processor 38 reads the image P3 temporarily stored in the third cache area 43 to display it. At this moment, the first cache area 41 stores the image P4 from the memory 32, at which time the image P2 is still stored in the second cache area 42. If the user desires to view the image P2 again, the processor 38 reads the image P2 temporarily stored in the second cache area 42 to display it through the display screen 34. At this moment, the first cache area 41 stores the image P1 from the memory 32, at which time the image P3 is still stored in the third cache area 43.

Please refer to FIG. 5, which is a flowchart of the file managing method used in the present invention. It occurs as follows:

Step202: Select an image.

Step204: Read the selected image, a previous displayed image, and a next image corresponding to the selected image from the memory.

Step206: Temporarily stores the selected image, the previous displayed image, and the next image corresponding to the selected image to a cache.

Step208: Read the selected image from the cache and display it.

In order to illustrates the present invention in detail, suppose that the digital camera 30 stores images P1-P6 in sequence. The user manipulates the control button set 36 to view the image P1. Meanwhile, the image P1 is read from the memory 32 and temporarily stored in the first cache area 41 of the cache 40, the image P2 is read from the memory 32 and temporarily stored in the second cache area 42 of the cache 40, and the image P6 is read from the memory 32 and temporarily stored in the third cache area 43 of the cache 40. Then, the processor 38 processes the image P1 stored in the first cache area 41 to display it on the display screen 34. If the user manipulates the control button set 36 to view the next image P2, the processor 38 processes the image P2 stored in the second cache area 42 to display it on the display screen 34. In the meantime, the image P3 is read from the memory 32 and temporarily stored in the third cache area 43, at which time the displayed image P1 is still stored in the first cache area 41. If the user wants to view the image P3, the processor 38 will read the image P3 stored in the third cache area 43 to display it, at this moment, the image P4 will be read from the memory 32 and temporarily stored in the first cache area 41, at which time the previous displayed image P2 is still stored in the second cache area 42. If the user wants to view the image P2 again, the processor 38 will read the image P2 stored in the second cache area 42 to display it, and the image P1 will be read from the memory 32 and stored in the first cache area 41 again, at which time the previous displayed image P3 is still stored in the third cache area 43.

The difference between the embodiment illustrated in FIG. 4 and the embodiment illustrated in FIG. 5 is the timing of storing the selected image, the previous displayed image and the next image to the cache. As shown in FIG. 4, when the selected image is displayed, the previous displayed image and the next image are stored in the cache at the same time. For the embodiment shown in FIG. 5, storing all the selected images, the previous displayed image and the next image in the cache is prior to displaying the selected image.

The cache can also stores the selected image, a plurality of displayed images, and a plurality of next images corresponding to the selected image. For example, before the image P3 is displayed, the previous displayed images P1, P2 and the next images P4, P5 can be stored in the cache. In this way, the user can shorten a wait time for reading and processing images.

The method according to the present invention can also be applied in digital camcorders. Although a digital camcorder records motion pictures, pre-reading one of the motion pictures also can shorten a wait time.

In contrast to prior art, the present invention method discloses that pre-reading a previous displayed image and a next image corresponding to a selected image from the memory 32 to a cache 40, while the selected image is being showed. In this way, a wait time of reading the previous displayed image or the next image is shortened because each is stored in the cache and ready to be displayed.

Those skilled in the art will readily observe that numerous modifications and alterations of the method may be made while retaining the teachings of the invention. Accordingly, the above disclosure should be construed as limited only by the metes and bounds of the appended claims.

1. A file managing method for an image capturing apparatus, the method comprising:
storing a plurality of taken images into a memory in sequence;
selecting one of the plurality of taken images; and
when displaying the selected image, reading at least one of the previous displayed images and at least one of the next images corresponding to the displaying image to a cache.

2. The method of claim 1, further comprising:
temporarily storing the image from the memory to the cache before displaying the selected image; and
reading the selected image from the cache.

3. The method of claim 1, wherein the cache is a synchronous DRAM.

4. The method of claim 1, wherein the image capturing apparatus is a digital camera or a digital camcorder.

5. A digital camera comprising:
a memory for storing a plurality of taken images in sequence;
a control button set for selecting a image from the plurality of images captured by the digital camera;
a display screen for displaying the selected image; and
a cache for temporarily storing at least one of the previous displayed images and at least one of the next images corresponding to the selected image before displaying the selected image.

6. The digital camera of claim 5, wherein the cache temporarily stores the displaying image and the display screen reads and displays the displaying image from the cache.

7. The digital camera of claim 5, wherein the cache is a synchronous DRAM.

8. A file managing method for an image capturing apparatus, the method comprising:
storing a plurality of taken images into a memory in sequence; and
before displaying one of the plurality of taken images, reading the image being going to be displayed, at least one of the previous displayed images and at least one of the next images corresponding to the image being going to be displayed to a cache.

9. The method of claim 8, further comprising:
after displaying the image prior to the selected image, reading at least one of the previous displayed images and at least one of the next images corresponding to the selected image.

10. The method of claim 8, wherein the cache is a synchronous DRAM.

11. The method of claim 8, wherein the image capturing apparatus is a digital camera or a digital camcorder.

12. A digital camera comprising:
a memory for storing a plurality of taken images in sequence;
a control button set for selecting a image from the plurality of images captured by the digital camera;
a display screen for displaying the selected image;
a cache for temporarily storing the selected image, at least one of the previous displayed images and at least one of the next images corresponding to the selected image, before displaying the selected image.

13. The digital camera of claim 12, wherein the cache is a synchronous DRAM.
